(19) United States
(12) Patent Application Publication
(10) Pub. No.: US 2021/0053626 A1
(43) Pub. Date: Feb. 25, 2021

(54) HEAT-REFLECTIVE RECREATIONAL VEHICLE BODY

(71) Applicant: Paul Spivak, Euclid, OH (US)

(72) Inventor: Paul Spivak, Euclid, OH (US)

(21) Appl. No.: 17/080,040

(22) Filed: Oct. 26, 2020

(51) Int. Cl. B62D 29/00; B60P 3/32

(52) U.S. Cl. CPC B62D 29/005; B32B 17/04; B32B 2605/08; B60P 3/32

(57) ABSTRACT

A recreational vehicle body includes a plurality of layers stacked and bonded together, the plurality of layers including a first gelcoat layer defining an exterior surface of the recreational vehicle body; and a first aluminized-FRP layer disposed on an interior side of the first gelcoat layer. The first aluminized-FRP layer includes a first aluminized-fiberglass-fabric.

### FIELD OF INVENTION

The following description relates to a recreational vehicle body, and more particularly a recreational vehicle body comprising a plurality of layers that includes an aluminized-fiber-reinforced-plastic layer.

### BACKGROUND OF THE INVENTION

Recreational vehicles are a trailer or motorized vehicle that includes living quarters designed for accommodation such as, for example, a kitchen, a bathroom, and one or more sleeping facilities. Common types of recreational vehicles include motorhomes, campervans, caravans (also known as travel trailers and camper trailers), fifth-wheel trailers, popup campers, and truck campers.

Recreational vehicles are commonly built using a molding process in which a female (negative) mold of the vehicle body is first constructed, and then layers of fiber-reinforced-plastic are applied within the mold to form an exoskeletal body of the recreational vehicle. In order to inhibit heat transfer through the body of the recreational vehicle, one or more layers of insulation are usually provided between layers of fiber-reinforced-plastic during the molding process. For example, Reflectix® Double Reflective Insulation is commonly used, which comprises bubble wrap having a metallic foil exterior.

However, applying such insulation between the layers of fiber-reinforced-plastic is very labor intensive and can mitigate the structural integrity of the overall body, since the bubble wrap provides little or no structural support. Moreover, arranging the insulation between outer layers of fiber-reinforced-plastic allows heat to transfer into and through the outer layers before reaching the insulation, thus mitigating the effectiveness of the overall body against heat transfer.

### BRIEF SUMMARY

In accordance with a first aspect, a recreational vehicle body includes a plurality of layers stacked and bonded together, the plurality of layers including a first gelcoat layer defining an exterior surface of the recreational vehicle body; and a first aluminized-FRP layer disposed on an interior side of the first gelcoat layer. The first aluminized-FRP layer includes a first aluminized-fiberglass-fabric.

In one example of the first aspect, the first aluminized-fiberglass-fabric includes a first fiberglass fabric and a first aluminum layer disposed on an exterior side of the first fiberglass fabric.

In another example of the first aspect, the plurality of layers further includes a first non-aluminized-FRP layer disposed on an interior side of the first aluminized-FRP layer, the first non-aluminized-FRP layer including a non-aluminized-fiberglass-fabric. In one example, the first non-aluminized-FRP layer is bonded directly to the first aluminized-FRP layer.

In yet another example of the first aspect, the first non-aluminized-FRP layer directly contacts the first aluminized-FRP layer.

In still yet another example of the first aspect, the plurality of layers further includes a core material layer disposed on an interior side of the first aluminized-FRP layer. In one example, the plurality of layers further includes a first non-aluminized-FRP layer disposed on an interior side of the core material. In another example, the plurality of layers further includes a second aluminized-FRP layer disposed on an interior side of the core material, and the second aluminized-FRP layer includes a second aluminized-fiberglass-fabric. In one example, the first aluminized-fiberglass-fabric includes a first fiberglass fabric and a first aluminum layer disposed on an exterior side of the first fiberglass fabric, and the second aluminized-fiberglass-fabric includes a second fiberglass fabric and a second aluminum layer disposed on an interior side of the second fiberglass fabric. In another example, the plurality of layers further includes a first non-aluminized-FRP layer disposed between the first aluminized-FRP layer and the core material; and a second non-aluminized-FRP layer disposed between the core material and the second aluminized-FRP layer, wherein the first non-aluminized-FRP layer and second non-aluminized-FRP layer each include a non-aluminized-fiberglass-fabric. In yet another example, the plurality of layers further includes a second gelcoat layer disposed on an interior side of the second aluminized-FRP layer, the second gelcoat layer defining an interior surface of the recreational vehicle body.

In another example of the first aspect, the first gelcoat layer is transparent or translucent.

In yet another example of the first aspect, a recreational vehicle includes the recreational vehicle body.

In accordance with a second aspect, a recreational vehicle body includes a plurality of layers stacked and bonded together. The plurality of layers includes a first gelcoat layer defining an exterior surface of the recreational vehicle body; a first aluminized-FRP layer disposed on an interior side of the first gelcoat layer; a core material layer disposed on an interior side of the first aluminized-FRP layer; a second aluminized-FRP layer disposed on an interior side of the core material; and a second gelcoat layer disposed on an interior side of the second aluminized-FRP layer, the second gelcoat layer defining an interior surface of the recreational vehicle body.

In one example of the second aspect, the first aluminized-fiberglass-fabric includes a first fiberglass fabric and a first aluminum layer disposed on an exterior side of the first fiberglass fabric, and the second aluminized-fiberglass-fabric includes a second fiberglass fabric and a second aluminum layer disposed on an interior side of the second fiberglass fabric.

In another example of the second aspect, the plurality of layers further includes a first non-aluminized-FRP layer disposed between the first aluminized-FRP layer and the core material layer; and a second non-aluminized-FRP layer disposed between the core material layer and the second aluminized-FRP layer. The first non-aluminized-FRP layer and second non-aluminized-FRP layer each include a non-aluminized-fiberglass-fabric. In one example, the first non-aluminized-FRP layer is bonded directly to the first aluminized-FRP layer, and the second non-aluminized-FRP layer is bonded directly to the second aluminized-FRP layer.

In yet another example of the second aspect, the first gelcoat layer and the second gelcoat layer are each transparent or translucent.

In accordance with a third aspect, a recreational vehicle body includes a plurality of layers stacked and bonded together. The plurality of layers includes a first gelcoat layer defining an exterior surface of the recreational vehicle body; a first aluminized-FRP layer disposed on an interior side of the first gelcoat layer, the first aluminized-FRP layer including a first aluminized-fiberglass-fabric; a first non-aluminized-FRP layer disposed on an interior side of the first aluminized-FRP layer, the first non-aluminized-FRP layer including a first non-aluminized-fiberglass-fabric; a core material layer disposed on an interior side of the first non-aluminized-FRP layer; a second non-aluminized-FRP layer disposed on an interior side of the core material, the second non-aluminized-FRP layer including a second non-aluminized-fiberglass-fabric; a second aluminized-FRP layer disposed on an interior side of the second non-aluminized-FRP layer, the second aluminized-FRP layer including a second aluminized-fiberglass-fabric; and a second gelcoat layer disposed on an interior side of the second aluminized-FRP layer, the second gelcoat layer defining an interior surface of the recreational vehicle body.

In one example of the third aspect, the first gelcoat layer and the second gelcoat layer are each transparent or translucent.

### BRIEF DESCRIPTION OF THE DRAWINGS

Embodiments of the invention are better understood when the following detailed description is read with reference to the accompanying drawings, in which:

FIG. 1 is a perspective view of a recreational vehicle;

FIG. 2 is a schematic cross-section view of a body member of the recreational vehicle;

FIG. 3 is a schematic cross-section view showing a step of a method for forming the body member;

FIG. 4 is a schematic cross-section view showing another step of the method that is subsequent to the step shown in FIG. 3;

FIG. 5 is a schematic cross-section view showing another step of the method that is subsequent to the step shown in FIG. 4;

FIG. 6 is a schematic cross-section view showing another step of the method that is subsequent to the step shown in FIG. 5;

FIG. 7 is a schematic cross-section view showing another step of the method that is subsequent to the step shown in FIG. 6;

FIG. 8 is a schematic cross-section view showing another step of the method that is subsequent to the step shown in FIG. 7;

FIG. 9 is a schematic cross-section view showing another step of the method that is subsequent to the step shown in FIG. 8; and

FIG. 10 is a schematic cross-section view showing another step of the method that is subsequent to the step shown in FIG. 9.

### DETAILED DESCRIPTION

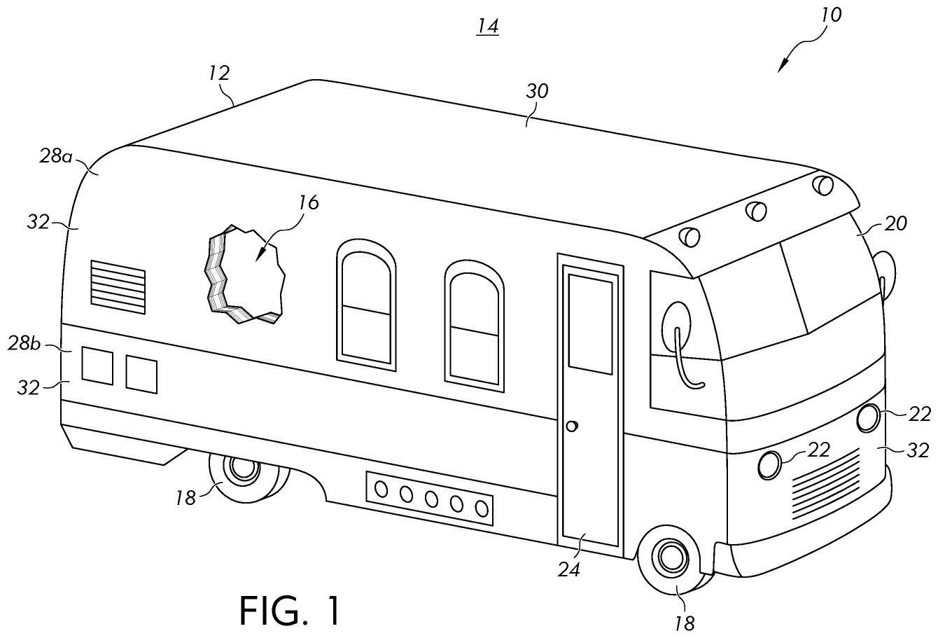

Turning to FIG. 1, a recreational vehicle 10 is shown that includes an exoskeletal body 12 defining an exterior 14 and an interior 16 of the body 12. The recreational vehicle 10 further includes a plurality of wheels 18 supporting the body 12, a windshield 20 and headlights 22 provided at a front end of the body 12, and a door 24 for providing selective access to the interior 16 of the body 12. The recreational vehicle 10 in the present example is a motorhome, meaning that it is a self-propelled recreational vehicle that offers mobile living accommodations within its interior 16 (e.g., a kitchen, a bathroom, and one or more sleeping facilities). However, the recreational vehicle 10 can be other types of recreational vehicles in other embodiments such as, for example, an unpowered trailer.

The body 12 of the recreational vehicle 10 includes a first body member 28a (i.e., an upper half shell) and a second body member 28b (i.e., a lower half shell). The body members 28a, 28b are each formed using a molding process and then assembled together (e.g., with fasteners or by welding) to form the body 12. Each body member 28a, 28b is a substantially dome-shaped body having a base 30 (e.g., floor or ceiling) and a plurality of side walls 32 that extend (e.g., upward or downward) from a perimeter of the base 30. When assembled together, the body members 28a, 28b collectively define the exterior 14 and interior 16 of the body 12.

The number and shapes of body members forming the body 12 can vary by embodiment. For instance, the body 12 in some examples can comprise a plurality of body members in the form of panels that each define a separate wall of the body 12. In other examples, the body 12 may consist of a single, dome-shaped body member that defines a ceiling and side walls of the recreational vehicle 10.

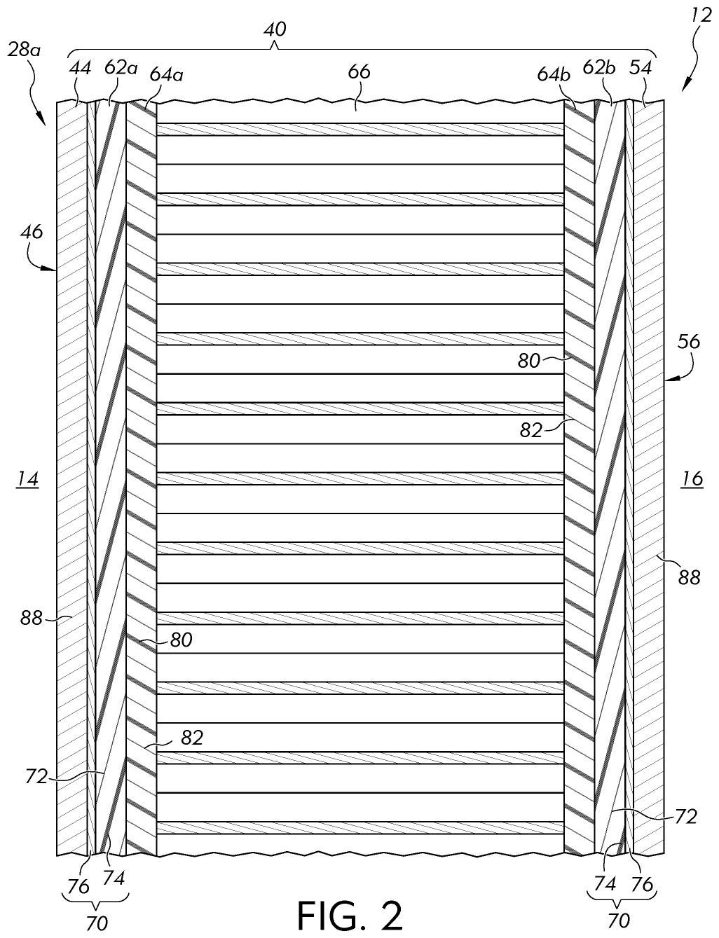

A construction of the body 12 will now be described with reference to FIG. 2, which shows a cross-section of a side wall 32 of the first body member 28a. It is to be appreciated that other portions of the first body member 28a and/or other members of the body 12 may have a similar construction. Indeed, the first and second body members 28a, 28b in the present example will have a similar construction along all of their walls.

As shown in FIG. 2, the first body member 28a comprises a plurality of layers 40 that are stacked and bonded together to form the first body member 28a. The plurality of layers 40 includes a first gelcoat layer 44 that defines an exterior surface 46 of the body member 28a, a second gelcoat layer 54 that defines an interior surface 56 of the body member 28a, a set of aluminized fiber-reinforced-plastic (FRP) layers 62a, 62b that are heat reflective and disposed between the first and second gelcoat layers 44, 54, a set of non-aluminized-FRP layers 64a, 64b disposed between the set of aluminized-FRP layers 62a, 62b, and a core material layer 66 disposed between the set of non-aluminized-FRP layers 64a, 64b. The layers 40 are therefore stacked such that the aluminized-FRP layer 62a is disposed on an interior side of the first gelcoat layer 44, the non-aluminized-FRP layer 64a is disposed on an interior side of the aluminized-FRP layer 62a, the core material layer 66 is disposed on an interior side of the non-aluminized-FRP layer 64a, the non-aluminized-FRP layer 64b is disposed on an interior side of the core material layer 66, the aluminized-FRP layer 62b is disposed on an interior side of the non-aluminized-FRP layer 64b, and the second gelcoat layer 54 is disposed on an interior side of the aluminized-FRP layer 62b.

For the purposes of this disclosure, the terms “exterior” and “interior” when describing features of the body 12 refer to a state of configuration relative to the exterior 14 and interior 16 of the body 12, respectively. For example, an “exterior surface” of a feature is surface of the feature that faces the exterior 14, whereas an “interior surface” of a feature is an opposite-facing surface of the feature that faces the interior 16. As another example, an “exterior side” of a feature is a side of the feature in which the exterior 14 is situated, whereas an “interior side” of a feature is an opposite side of the feature in which the interior 16 is situated.

The aluminized-FRP layers 62a, 62b each comprise an aluminized-fiberglass-fabric 70 that is woven and impregnated (i.e., saturated) with resin 72 in an uncured state and then cured to form the FRP layer. The aluminized-fiberglass-fabric 70 comprises a woven fiberglass fabric 74 and an aluminum layer 76 that is applied onto a surface of the fiberglass fabric 74 (e.g., by spraying, sputtering, or adhesively bonding) to coat the fiberglass fabric 74. The aluminized-fiberglass-fabric 70 of the FRP layer 62a is arranged such that its aluminum layer 76 is disposed on an exterior side of its fiberglass fabric 74, and the aluminized-fiberglass-fabric 70 of the FRP layer 62b is arranged such that its aluminum layer 76 is disposed on an interior side of its fiberglass fabric 74.

However, it is to be appreciated that the aluminum layers 76 of the aluminized-fiberglass-fabrics 70 can be arranged on opposite sides of their associated fabrics 75 in other examples. Moreover, the aluminized-FRP layers 62a, 62b can comprise other materials and/or configurations in other examples. For instance, the aluminized-FRP layers 62a, 62b can each comprise a composite coated with aluminum, wherein the composite is formed by impregnating a mat of loose fibers (e.g., glass, Kevlar, carbon, etc.) with resin. Generally speaking, each FRP layer 62a, 62b can comprise any configuration of FRP that includes aluminum.

The presence of aluminum in the FRP layers 62a, 62b enables the layers to reflect heat away from the body member 28a, thereby improving the body's resistance to heat transfer. That is, heat transferring from the exterior 14 into the body member 28a will be reflected by the FRP layer 62a back towards the exterior 14, while heat transferring from the interior 16 into the body member 28a will be reflected by the FRP layer 62b back towards the interior 16. This reflection is particularly enhanced by orienting the FRP layers 62a, 62b such that the aluminum layer 76 of the FRP layer 62a is disposed on the exterior side of its fiberglass fabric 74, and the aluminum layer 76 of the FRP layer 62b is disposed on the interior side of its fiberglass fabric 74. Moreover, by disposing the core material layer 66 and the non-aluminized-FRP layers 64a, 64b between the aluminized-FRP layers 62a, 62b, heat entering the body member 28a from either side (i.e., the interior side or exterior side) will be reflected away from the body member 28a before transferring into those layers 64a, 64b, 66, thereby preventing those layers 64a, 64b, 66 from absorbing/transferring heat.

The non-aluminized-FRP layers 64a, 64b, on the other hand, do not include any aluminum. Rather, the FRP layers 64a, 64b in the present example each comprise a non-aluminized-fiberglass-fabric 80 that is woven and impregnated with resin 82 in an uncured state and then cured to form the FRP layer. For the purposes of this disclosure, a “non-aluminized-fiberglass-fabric” is a fiberglass fabric that does not have a layer of aluminum directly bonded on it. However, in other example, the FRP layers 64a, 64b can comprise a composite formed by impregnating a mat of loose fibers (e.g., glass, Kevlar, carbon, etc.) with resin. Generally speaking, each FRP layer 64a, 64b can comprise any configuration of FRP that does not include aluminum.

The FRP layers 64a, 64b strengthen the body member 28a by adding further layers of FRP to its construction. Moreover, since the aluminized-FRP layers 62a, 62b will reflect heat away from the body member 28a before reaching the FRP layers 64a, 64b, the FRP layers 64a, 64b can be made without aluminum, thereby mitigating their cost.

The core material layer 66 in the present example comprises plastic honeycomb, which is a light-weight body that can add strength to the body member 28a. However, the core material layer 66 can comprise other materials with similar or alternative benefits in other examples. For instance, the core material layer 66 can comprise balsa wood, which is a similarly light-weight material that can add strength to the body member 28a. In another example, the core material layer 66 can comprise foam or some other insulating body that can further improve the body's resistance to heat transfer.

The first and second gelcoat layers 44, 54 each comprise a thin layer of resin 88 that serves as a finishing coat for the body member 28a. Each layer of resin 88 can be 10 to 24 mils (i.e., thousands of an inch) thick and preferably, 18 to 20 mils thick, although other thicknesses may be possible. In some examples, each layer of resin 88 can be colored to provide a desired aesthetic appearance to the body member 28a. However, each layer of resin 88 will preferably be translucent or transparent to maximize the reflectivity of the aluminized-FRP layers 62a, 62b described above. For example, each layer of resin 88 can have an opacity that is 50% or less, preferably 40% or less, and more preferably 30% or less.

The layers 40 described above can be bonded together such that each layer 40 is directly bonded to its adjacent layer 40. For the purposes of this disclosure, two features are “directly bonded” to each other if they are bonded in direct contact with each other, or if they are both in direct contact with an intermediate layer of adhesive. For instance, in the present example, the FRP layer 62a is bonded in direct contact with the first gelcoat layer 44, the FRP layer 64a is bonded in direct contact with the FRP layer 62a, the core material layer 66 is bonded in direct contact with the FRP layer 64a, the FRP layer 64b is bonded in direct contact with the core material layer 66, the FRP layer 62b is bonded in direct contact with the FRP layer 64b, and the second gelcoat layer 54 is bonded in direct contact with the FRP layer 62b.

The resins described above can each comprise a thermosetting resin (e.g., epoxy, polyester, or vinyl ester) that is initially in fluid form and combined with a curing agent to cure the resin to a hardened state. For instance, one or more of the resins can comprise a polyester or vinyl ester resin that is combined with a peroxide catalyst (e.g., Conap and MEKP) at a catalyst-to-resin ratio of 0.05 to 3.00%. Curing time for such a mixture can be about 45 to 60 minutes. However, other types of resins, curing agents, mixture ratios, and/or curing times may be possible in other examples.

It is to be appreciated that the construction of the body member 28a described above is merely an example and that other constructions may be possible in other embodiments. For instance, the body member 28a may include additional layers 40 such as additional FRP layers or core material layers to help strengthen and/or insulate the body member 28a. In such examples, the additional layers can be disposed between the FRP layers 62a, 62b so that heat is reflected away from the body member 28a before reaching the additional layers. Moreover, additional FRP layers can be non-aluminized to mitigate their cost.

As another example, the body member 28a may comprise fewer layers than those described above. For instance, the body member 28a in some examples may simply comprise the first gelcoat layer 44 and FRP layer 62a. Since the FRP layer 62a is aluminized, the body member 28a can still provide better resistance to heat transfer than a similar body member that has a non-aluminized-FRP layer.

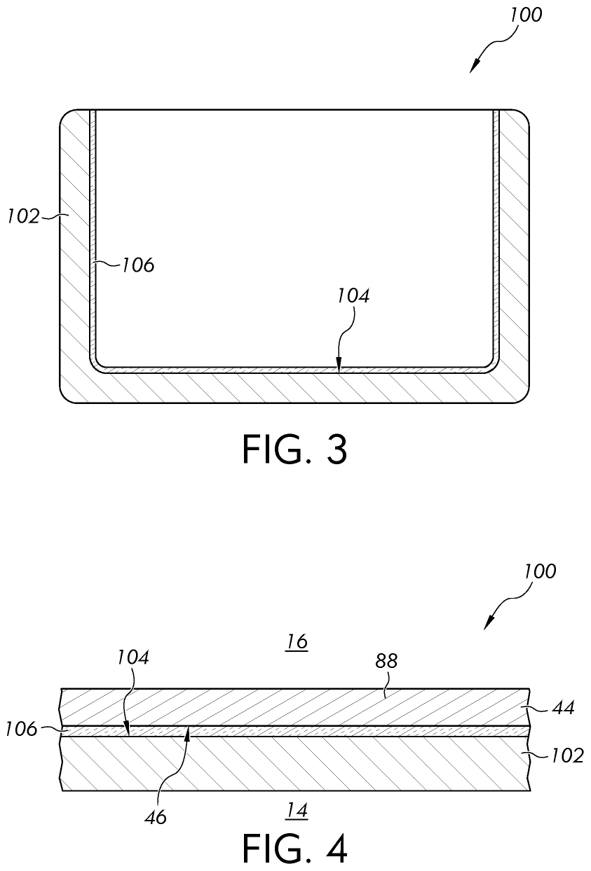

Turning to FIGS. 3-10, a method 100 of constructing the body member 28a will now be described. It is to be appreciated that other members of the body 12 (e.g., the body member 28b) can be constructed according to a similar method 100.

As shown in FIG. 3, the method 100 includes providing a female (negative) mold 102 of the body member 28a. The mold 102 is a dome-shaped body having an inner surface 104 that substantially matches the desired shape of the first body member's exterior surface 46. As discussed below, the layers 40 of the body member 28a will be successively applied within the mold 102 to form the body member 28a. Prior to applying the layers 40, the method 100 will preferably include a step of coating the inner surface 104 of the mold 102 with a mold release agent 106 to prevent the body member 28a from bonding to the mold 102.

As shown in FIG. 4, the method 100 next includes a step of applying the first gelcoat layer 44 against the inner surface 104 of the mold 102. In particular, the resin 88 can be applied against the lubricated inner surface 104 in an uncured state and then cured to form the first gelcoat layer 44.

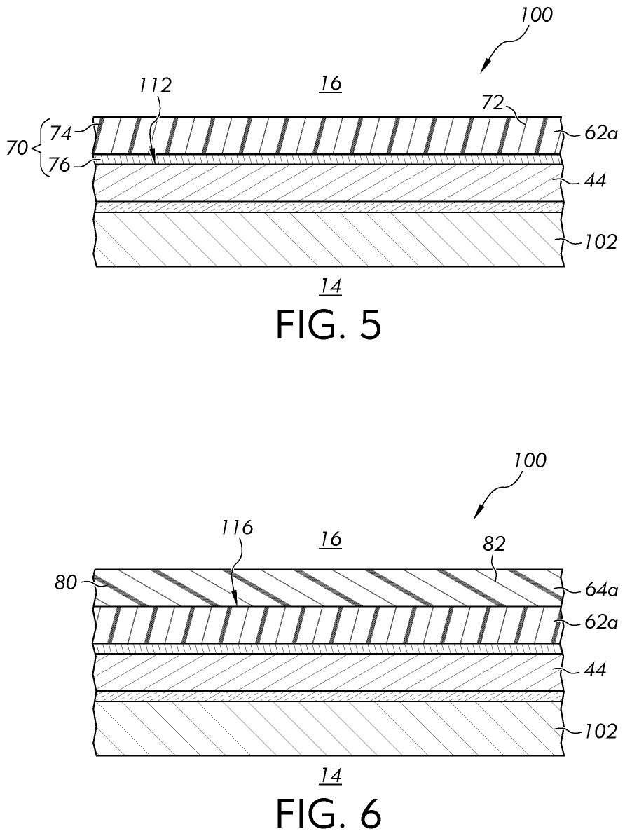

As shown in FIG. 5, the method 100 next includes a step of applying the FRP layer 62a against an interior surface 112 of the first gelcoat layer 44. In particular, the aluminized-fiberglass-fabric 70 can be applied against the interior surface 112, either by placing the fabric 70 directly in contact with the interior surface 112 or by bonding the fabric 70 to the interior surface 112 with an intermediate adhesive. Preferably, the aluminized-fiberglass-fabric 70 is oriented such that its aluminum layer 76 is disposed on the exterior side of its fiberglass fabric 74. The resin 72 is then applied to saturate the fabric 70 and allowed to cure to complete the FRP layer 62a. The FRP layer 62a as applied will be directly bonded to the first gelcoat layer 44.

As shown in FIG. 6, the method 100 next includes a step of applying the FRP layer 64a against an interior surface 116 of the FRP layer 62a. In particular, the non-aluminized-fiberglass-fabric 80 can be applied against the interior surface 116, either by placing the fabric 80 directly in contact with the interior surface 116 or by bonding the fabric 80 to the interior surface 116 with an intermediate adhesive. The resin 82 is then applied to saturate the fabric 80 and allowed to cure to complete the FRP layer 64a. The FRP layer 64a as applied will be directly bonded to the FRP layer 62a.

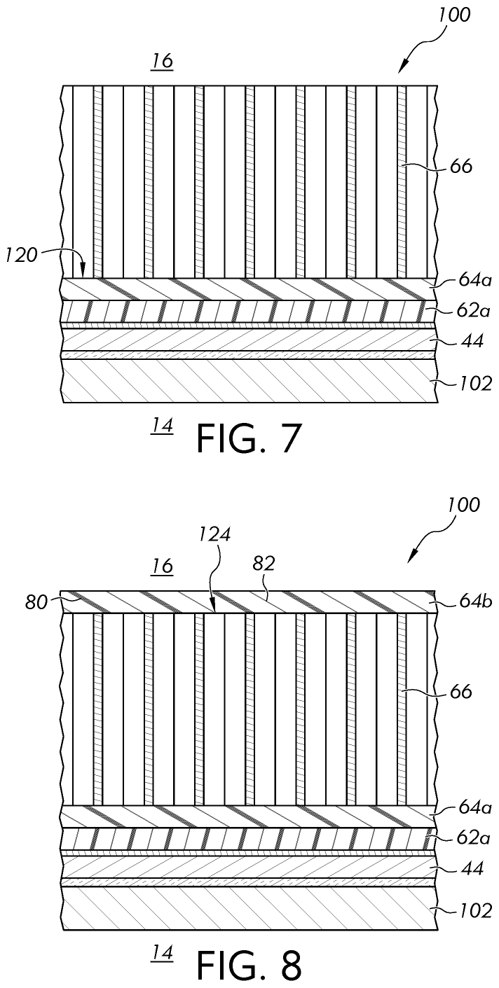

As shown in FIG. 7, the method 100 next includes a step of applying the core material layer 66 against an interior surface 120 of the FRP layer 64a. In particular, the core material layer 66 can be applied against the interior surface 120, either by placing the layer 66 directly in contact with the interior surface 120 or by bonding the layer 66 to the interior surface 120 with an intermediate adhesive. The core material layer 66 as applied will be directly bonded to the FRP layer 64a.

As shown in FIG. 8, the method 100 next includes a step of applying the FRP layer 64b against an interior surface 124 of the core material layer 66. In particular, the non-aluminized-fiberglass-fabric 80 can be applied against the interior surface 124, either by placing the fabric 80 directly in contact with the interior surface 124 or by bonding the fabric 80 to the interior surface 124 with an intermediate adhesive. The resin 82 is then applied to saturate the fabric 80 and allowed to cure to complete the FRP layer 64b. The FRP layer 64b as applied will be directly bonded to the core material layer 66.

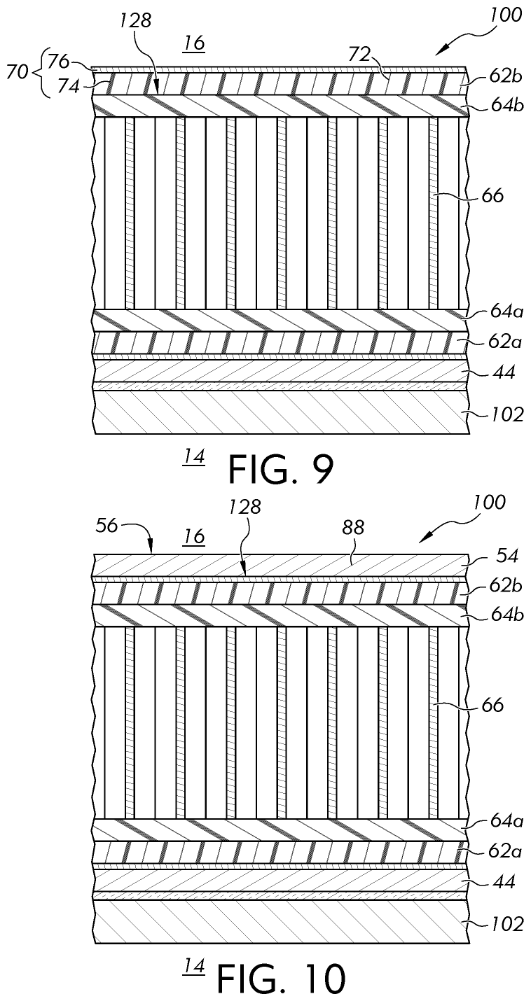

As shown in FIG. 9, the method 100 next includes a step of applying the FRP layer 62b against an interior surface 128 of the FRP layer 64b. In particular, the aluminized-fiberglass-fabric 70 can be applied against the interior surface 128, either by placing the fabric 70 directly in contact with the interior surface 128 or by bonding the fabric 70 to the interior surface 128 with an intermediate adhesive. Preferably, the aluminized-fiberglass-fabric 70 is oriented such that its aluminum layer 76 is disposed on the interior side of its fiberglass fabric 74. The resin 72 is then applied to saturate the fabric 70 and allowed to cure to complete the FRP layer 62b. The FRP layer 62b as applied will be directly bonded to the FRP layer 64b.

As shown in FIG. 10, the method 100 next includes a step of applying the second gelcoat layer 54 against an interior surface 132 of the FRP layer 62b. In particular, the resin 88 can be applied against the interior surface 132 in an uncured state and then cured to form the second gelcoat layer 54. Once the second gelcoat layer 54 is complete, the body member 28a can be removed from the mold 102 and assembled with the body member 28b to form the body 12 of the recreational vehicle 10.

In the method 100 described above, the resins will initially be uncured and mixed with a curing agent prior to application within the mold 102. For example, one or more of the resins can comprise a polyester or vinyl ester resin that is combined with a peroxide catalyst (e.g., Conap and MEKP) at a catalyst-to-resin ratio of 0.05 to 3.00%. Once mixed, the resin can be applied within the mold 102 (e.g., by spraying or brushing) and given time to cure to a hardened state. Curing time for such a mixture can be about 45 to 60 minutes.

Illustrative embodiments have been described, hereinabove. It will be apparent to those skilled in the art that the above apparatuses and methods may incorporate changes and modifications without departing from the scope of this disclosure. The invention is therefore not limited to particular details of this disclosure, and will encompass modifications and adaptions thereof within the spirit and the scope of the appended claims.

What is claimed is:

1. A recreational vehicle body comprising a plurality of layers stacked and bonded together, the plurality of layers comprising:
a first gelcoat layer defining an exterior surface of the recreational vehicle body; and
a first aluminized-FRP layer disposed on an interior side of the first gelcoat layer, wherein the first aluminized-FRP layer comprises a first aluminized-fiberglass-fabric.

2. The recreational vehicle body of claim 1, wherein the first aluminized-fiberglass-fabric comprises a first fiberglass fabric and a first aluminum layer disposed on an exterior side of the first fiberglass fabric.

3. The recreational vehicle body of claim 1, wherein the plurality of layers further comprises a first non-aluminized-FRP layer disposed on an interior side of the first aluminized-FRP layer, the first non-aluminized-FRP layer comprising a non-aluminized-fiberglass-fabric.

4. The recreational vehicle body of claim 3, wherein the first non-aluminized-FRP layer is bonded directly to the first aluminized-FRP layer.

5. The recreational vehicle body of claim 1, wherein the first non-aluminized-FRP layer directly contacts the first aluminized-FRP layer.

6. The recreational vehicle body of claim 1, wherein the plurality of layers further comprises a core material layer disposed on an interior side of the first aluminized-FRP layer.

7. The recreational vehicle body of claim 6, wherein the plurality of layers further comprises a first non-aluminized-FRP layer disposed on an interior side of the core material.

8. The recreational vehicle body of claim 6, wherein the plurality of layers further comprises a second aluminized-FRP layer disposed on an interior side of the core material, wherein the second aluminized-FRP layer comprises a second aluminized-fiberglass-fabric.

9. The recreational vehicle body of claim 8, wherein:
the first aluminized-fiberglass-fabric comprises a first fiberglass fabric and a first aluminum layer disposed on an exterior side of the first fiberglass fabric, and
the second aluminized-fiberglass-fabric comprises a second fiberglass fabric and a second aluminum layer disposed on an interior side of the second fiberglass fabric.

10. The recreational vehicle body of claim 8, wherein the plurality of layers further comprises:
a first non-aluminized-FRP layer disposed between the first aluminized-FRP layer and the core material; and
a second non-aluminized-FRP layer disposed between the core material and the second aluminized-FRP layer,
wherein the first non-aluminized-FRP layer and second non-aluminized-FRP layer each comprise a non-aluminized-fiberglass-fabric.

11. The recreational vehicle body of claim 8, wherein the plurality of layers further comprises a second gelcoat layer disposed on an interior side of the second aluminized-FRP layer, the second gelcoat layer defining an interior surface of the recreational vehicle body.

12. The recreational vehicle body of claim 1, wherein the first gelcoat layer is transparent or translucent.

13. A recreational vehicle comprising the recreational vehicle body of claim 1.

14. A recreational vehicle body comprising a plurality of layers stacked and bonded together, the plurality of layers comprising:
a first gelcoat layer defining an exterior surface of the recreational vehicle body;
a first aluminized-FRP layer disposed on an interior side of the first gelcoat layer;
a core material layer disposed on an interior side of the first aluminized-FRP layer;
a second aluminized-FRP layer disposed on an interior side of the core material; and
a second gelcoat layer disposed on an interior side of the second aluminized-FRP layer, the second gelcoat layer defining an interior surface of the recreational vehicle body.

15. The recreational vehicle body of claim 14, wherein:
the first aluminized-fiberglass-fabric comprises a first fiberglass fabric and a first aluminum layer disposed on an exterior side of the first fiberglass fabric, and
the second aluminized-fiberglass-fabric comprises a second fiberglass fabric and a second aluminum layer disposed on an interior side of the second fiberglass fabric.

16. The recreational vehicle body of claim 14, the plurality of layers further comprising:
a first non-aluminized-FRP layer disposed between the first aluminized-FRP layer and the core material layer; and
a second non-aluminized-FRP layer disposed between the core material layer and the second aluminized-FRP layer,
wherein the first non-aluminized-FRP layer and second non-aluminized-FRP layer each comprise a non-aluminized-fiberglass-fabric.

17. The recreational vehicle body of claim 16, wherein the first non-aluminized-FRP layer is bonded directly to the first aluminized-FRP layer, and the second non-aluminized-FRP layer is bonded directly to the second aluminized-FRP layer.

18. The recreational vehicle body of claim 14, wherein the first gelcoat layer and the second gelcoat layer are each transparent or translucent.

19. A recreational vehicle body comprising a plurality of layers stacked and bonded together, the plurality of layers comprising:
a first gelcoat layer defining an exterior surface of the recreational vehicle body;
a first aluminized-FRP layer disposed on an interior side of the first gelcoat layer, the first aluminized-FRP layer comprising a first aluminized-fiberglass-fabric;
a first non-aluminized-FRP layer disposed on an interior side of the first aluminized-FRP layer, the first non-aluminized-FRP layer comprising a first non-aluminized-fiberglass-fabric;
a core material layer disposed on an interior side of the first non-aluminized-FRP layer;
a second non-aluminized-FRP layer disposed on an interior side of the core material, the second non-aluminized-FRP layer comprising a second non-aluminized-fiberglass-fabric;
a second aluminized-FRP layer disposed on an interior side of the second non-aluminized-FRP layer, the second aluminized-FRP layer comprising a second aluminized-fiberglass-fabric; and
a second gelcoat layer disposed on an interior side of the second aluminized-FRP layer, the second gelcoat layer defining an interior surface of the recreational vehicle body.

20. The recreational vehicle body of claim 19, wherein the first gelcoat layer and the second gelcoat layer are each transparent or translucent.
